(19) United States
(12) Patent Application Publication
(10) Pub. No.: US 2003/0011102 A1
(43) Pub. Date: Jan. 16, 2003

(54) Method of making a sculpture

(76) Inventor: Kuo-Sheng Lin, Miaoli Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/903,569

(22) Filed: Jul. 13, 2001

(51) Int. Cl. B29C 33/40

(52) U.S. Cl. 264/227

(57) ABSTRACT

A sculpture manufacturing method comprises inputting a photograph or a picture; processing and analyzing the photograph or picture for converting it into a computer image; using a computer aided device to carve an acrylic board to form an acrylic mold; converting acrylic mold into a silicone mold; converting silicone mold into a plaster mold; pouring pottery or porcelain material into plaster mold; curing plaster mold for obtaining a pottery or porcelain mold; and first baking, cooling, coating, and second baking the same for forming the sculpture. It is advantageous for being quick, cost effective, and visually attractive.

### FIELD OF THE INVENTION

The present invention relates to sculptures and more particularly to a novel and improved method of making a sculpture.

### BACKGROUND OF THE INVENTION

Conventionally, a variety of decorations are formed on lights, light shades, acrylic boards, or mirror frames for obtaining an aesthetic appearance and adding value thereto. Typically, such decorations are done manually by carving or modeling clay prior to mass production. However, these decorations are two-dimensional representations, thus detracting the aesthetic appearance of products coupled thereto. Further, wedding pictures, important patterns, etc. are not possible of being made into moldings because prior art does not have the required precision in addition to other adverse factors of time consuming and cost ineffective. Furthermore, as to the materials for making decorations or sculptures they are only glass, stones, or crystals. This is because these materials can reflect light. However, pottery and porcelain are not utilized for making decorations and sculptures. This limits the variety of selectable materials. Thus, it is desirable to provide a new and improved method of making a sculpture in order to overcome the above drawbacks of prior art.

### SUMMARY OF THE INVENTION

It is an object of the present invention to provide a method of making sculpture wherein manufacturing processes thereof are advantageous for being quick, cost effective, and high applicability.

It is another object of the present invention to provide a method of making sculpture wherein sculptures thus formed are aesthetic, true representations, and high quality.

It is still another object of the present invention to provide a method of making sculpture wherein the materials selected are wider as compared to conventional method.

To achieve the above and other objects, the present invention provides a manufacturing method comprising the steps of inputting a photograph or a picture; processing and analyzing the photograph or picture for converting it into a computer image and obtaining a negative and performing a color separation; using a computer aided device or laser to carve a hard board such as acrylic board to form an acrylic mold by referring to negative and color separation; converting acrylic mold into a silicone mold; converting silicone mold into a plaster mold; pouring pottery or porcelain material into plaster mold; curing plaster mold for obtaining a pottery or porcelain mold; and first baking, cooling, coating, and second baking pottery or porcelain mold for forming a sculpture.

The above and other objects, features and advantages of the present invention will become apparent from the following detailed description taken with the accompanying drawings.

### BRIEF DESCRIPTION OF THE DRAWINGS

FIG. 1 is a flow chart illustrating a process for making a sculpture according to the invention.

### DETAILED DESCRIPTION OF THE PREFERRED EMBODIMENTS

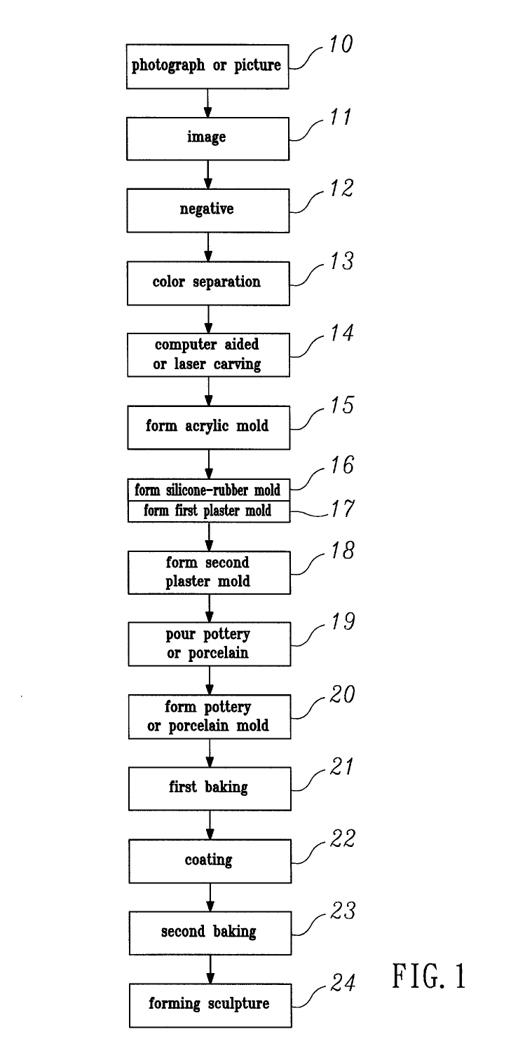

Referring to FIG. 1, there is shown a process for making a sculpture in accordance with the invention comprising the following steps:

Step 10: Prepare a photograph or picture to be made into a sculpture.

Step 11: Process the photograph or picture for converting it into a computer image.

Step 12: Process the image for obtaining a negative.

Step 13: Perform a color separation on the negative wherein a precise projection analysis is done on the negative for obtaining data for subsequent carving reference.

Step 14: Use a computer aided device or laser to carve a hard material (e.g., acrylic board) by utilizing above color separation data. This is a contrast to conventional manual modeling on clay.

Step 15: An acrylic mold is formed by above computer aided or laser carving.

Step 16: Convert the acrylic mold into a silicone-rubber mold. Such flexible rubber mold is advantageous for being capable of forming a three-dimensional representation. Alternatively, it is possible of converting the acrylic mold into a first plaster mold (i.e., hard in nature) in step 17.

Step 18: Further convert the rubber or plaster mold into a second plaster mold.

Step 19: Pour pottery or porcelain material into second plaster mold.

Step 20: Cure the second plaster mold for obtaining a pottery or porcelain mold (i.e., three-dimensional representation).

Step 21: Bake the pottery or porcelain mold in a temperature about 1,280° C.

Steps 22 and 23: Cool the baked pottery (or porcelain) mold prior to coating and baking in a temperature about 150° C. to about 800° C. wherein coating is done by first coating a colored paint on the baked pottery (or porcelain) mold and subsequently coating a colorless paint on the first coating.

Step 24: A final sculpture is formed. This final sculpture has a pleasing appearance. Further, the color thereof does not tend to fade.

The advantage of the present invention includes:

(1) Image analysis, computer aided (or laser) carving, and silicone-rubber/plaster mold are employed. This is a contrast to conventional manual clay modeling and single plaster mold technique.

(2) Silicone-rubber is stable and flexible in nature, thus facilitating the making of the three-dimensional representation of sculpture. Moreover, such silicone mold is clear in texture, thus enhancing the quality of a final sculpture. In addition, since silicone-rubber is not capable of absorbing water silicone mold and combined plaster mold are utilized by the present invention for absorbing water. This is essential to the success of making pottery (or porcelain) mold.

(3) Quality of thus formed sculpture is improved significantly.

(4) Such manufacturing method is adapted to personal customization or small scale production.

(5) The manufacturing processes are quick, cost effective, and high applicability.

(6) Sculptures thus formed are aesthetic, true representations, and high quality.

(7) Materials selected for making sculptures (e.g., pottery and porcelain material) are wider as compared to conventional methods.

(8) A fine product done by prior art is possible only by a skilled sculptor. Hence, personal sculpture is substantially impossible of making. In contrast, the invention eliminates above prior art drawbacks.

(9) A personal photograph or picture may be employed as source for making a pottery or porcelain sculpture. Hence, it is valuable.

While the invention herein disclosed has been described by means of specific embodiments, numerous modifications and variations could be made thereto by those skilled in the art without departing from the scope and spirit of the invention set forth in the claims.

What is claimed is:

1. A manufacturing method comprising the steps of:
(a) inputting a photograph or a picture;
(b) processing and analyzing said photograph or said picture for converting it into a computer image;
(c) using a device to carve a board member to form a first mold by utilizing said image;
(d) converting said first mold into a flexible second mold;
(e) converting said second mold into a plaster mold and pouring a material into said plaster mold for forming a third mold; and
(f) baking said third mold, cooling said third mold, and forming a sculpture.

2. The method of claim 1, wherein in the step (b) further comprises the step of processing said image for obtaining a negative.

3. The method of claim 2, wherein in the step (b) further comprises the step of performing a color separation on said negative.

4. The method of claim 1, wherein said board member in the step (c) is formed of hard material.

5. The method of claim 1, wherein said board member in the step (c) is formed of acrylic.

6. The method of claim 1, wherein said device in the step (c) is a computer aided device.

7. The method of claim 1, wherein said device in the step (c) is a laser.

8. The method of claim 1, wherein said first mold is a rubber mold.

9. The method of claim 1, wherein said first mold is a silicone-rubber mold.

10. The method of claim 1, wherein said first mold is a plaster mold.

11. The method of claim 1, wherein said material poured into said plaster mold is a pottery or porcelain.

12. The method of claim 1, wherein in step (f) further comprises the step of coating said third mold prior to forming said sculpture.

13. The method of claim 12, wherein the coating step comprises the sub-steps of coating a colored paint on said third mold and coating a colorless paint on said colored paint.

14. The method of claim 12, wherein in the step (f) further comprising the step of baking after the coating step.

15. A manufacturing method comprising the steps of:
(a) inputting a photograph or a picture;
(b) processing and analyzing said photograph or said picture for converting it into a computer image;
(c) using a device to carve a hard board to form a first mold by utilizing said image;
(d) converting said first mold into a first plaster mold;
(e) converting said first plaster mold into a second plaster mold and pouring a pottery or porcelain into said plaster second mold for forming a pottery or porcelain mold; and
(f) baking said pottery or porcelain mold, cooling said pottery or porcelain mold, and forming a sculpture.
